(19) United States
(12) Patent Application Publication
(10) Pub. No.: US 2026/0131542 A1
(43) Pub. Date: May 14, 2026

(54) METHOD OF OPERATING AUTOMATED FIBER PLACEMENT SYSTEM

(71) Applicant: Lockheed Martin Corporation, Bethesda, MD (US)

(72) Inventors: Alex Brasington, New Haven, CT (US); Vincent Cheung, Stratford, CT (US); Yih-Farn Chen, Stratford, CT (US); Phimvaly Sarawichitr, Fort Worth, TX (US)

(73) Assignee: Lockheed Martin Corporation, Bethesda, MD (US)

(21) Appl. No.: 18/945,871

(22) Filed: Nov. 13, 2024

(51) Int. Cl. B29C 70/38; B29C 70/12; B29C 70/54; B29K 307/04; B29L 31/08; F01D 5/14; F01D 5/28

(52) U.S. Cl. CPC B29C 70/384; B29C 70/12; B29C 70/545; F01D 5/147; F01D 5/282; B29C 2793/0081; B29K 2307/04; B29L 2031/082; F05D 2240/30

(57) ABSTRACT

A method of operating an automated fiber placement system includes supplying a plurality of tows to a tow deposition assembly of an automated fiber placement head, cutting a first tow into a first upstream and downstream tow portions, continuing to supply the first tow through a compaction roller to apply the first tow to a substrate such that a trailing edge of the first upstream tow portion substantially aligns with a leading edge of the first downstream tow portion at a first interface, cutting a second tow into a second upstream and downstream tow portions, and continuing to supply the second tow through the compaction roller to apply the second tow the substrate such that a trailing edge of the second upstream tow portion substantially aligns with a leading edge of the second downstream tow portion at a second interface that is offset from the first interface.

### BACKGROUND

A rotor blade of a rotary-wing aircraft may include a spar that extends outboard from the blade root coupled to the rotor hub and acts as the main structural component of the blade. Upper and lower skins may be coupled to the spar to form the airfoil of the rotor blade. Traditionally, rotorcraft blade composite spars are fabricated by hand, for example, using a composite material made of pre-impregnated fibers (“pre-preg”), e.g., in a lay-up of composite materials. Prepregs are hand-stacked and interleaved upon a male mandrel assembly. The lay-up is then placed in a mold and cured to form the finished composite spar.

More recently, Automated Fiber Placement (AFP) has been used to build rotor blade spars. Automated Fiber Placement (AFP) involves the placement of tapes, or “tows” of fibers by a robotically controlled print head. The fibers can be pre-impregnated with a resin, for example, a thermoset resin, partially cured so they can be handled, applied with a backing, and then rolled onto spools in tape form. The tows are then fed through the print head, where the backing is removed, tows are aligned, and a compaction roller presses a strip of tows onto the surface of a mold. After the application of the tape is complete, the mold may be moved into an autoclave, where curing of the resin can be completed.

### SUMMARY OF THE INVENTION

Manual manufacturing of rotor blade spars can include applying a first prepreg ply around half of the mandrel and a second prepreg ply around the other half of the mandrel and mating with the edges of the first ply such that the first and second plies surround the entire mandrel. These plies are sometimes referred to as “clamshell” plies and can be arranged such that they extend directly around the mandrel (e.g., perpendicular to the longitudinal axis of the mandrel) or at an angle (e.g., approximately 45 degrees to the longitudinal axis of the mandrel).

This “clamshell” design may also be useful when manufacturing spars using AFP. For example, by wrapping only about half of the mandrel, access to all sides of the mandrel may not be needed. Thus, the mandrel may be stationary (e.g., not rotated about its longitudinal axis), and the AFP head may traverse one side of the mandrel, covering the entire first side before the mandrel is flipped and the other side is covered. However, this process can be disadvantageous in that the AFP head may only be configured to lay the strip of tows in one direction. Thus, to cover the entire first half of the mandrel, after laying a strip, the AFP head must be pulled away from the mandrel, rotated 180 degrees, and translated to an uncovered portion of the mandrel before a second strip can be laid. This results in a relatively high amount of “off-part time” when tows are not being laid onto the mandrel, significantly slowing the process. Cutting the tows and restarting after each pass also results in “tow wandering” when the ends of the tows drift out of place before adhering to the mandrel. These disadvantages may be avoided by forgoing the “clamshell” arrangement and continuously wrapping the tows around the mandrel, for example, by rotating the mandrel about its longitudinal axis while controlling the position of the AFP head. However, as appreciated by the inventors of the present disclosure, if the tows are not cut, the uncured spar is not able to expand into the mold during curing. The cuts in the carbon fiber material act as expansion joints that ensure that the uncured spar can “grow” into the mold.

The present disclosure describes a method of manufacturing a rotor blade spar or other similar structures (e.g., fixed-wing aircraft spars, other roughly tubular structures, etc.) using AFP that minimizes “off-part” time while not restricting the expansion of the uncured material into a female mold. The method includes continuously applying a strip of tows around the mandrel while periodically cutting a subset of the tows in the strip. Because only a subset of tows are cut, the remaining tows help to guide the cut tows into position, reducing the likelihood of tow wandering. The method also provides a method of minimizing the gaps formed by cut tows by activating an add roller immediately after cutting a tow to keep the upstream portions of the tow moving through the AFP head. The method may include cutting alternating tows in the strip. For example, in a strip with eight tows, the first, third, fifth, and seventh tows in the strip may be cut simultaneously. After continuing to lay the strip around the mandrel, the second, fourth, sixth, and eighth tows may be cut simultaneously. In other embodiments, each tow may be cut at different times so that the cuts of no two tows are aligned.

In some aspects, the techniques described herein relate to a method of operating an automated fiber placement system, the method including supplying a plurality of tows to a tow deposition assembly of an automated fiber placement head of the automated fiber placement system, the plurality of tows including a first tow and a second tow; cutting the first tow of the plurality of tows within the tow deposition assembly into a first upstream tow portion and a first downstream tow portion; continuing to supply the first tow through a compaction roller of the automated fiber placement head to apply the first tow to a substrate such that a trailing edge of the first upstream tow portion substantially aligns with a leading edge of the first downstream tow portion at a first interface; cutting the second tow of the plurality of tows within the tow deposition assembly into a second upstream tow portion and a second downstream tow portion; and continuing to supply the second tow through the compaction roller to apply the second tow to the substrate such that a trailing edge of the second upstream tow portion substantially aligns with a leading edge of the second downstream tow portion at a second interface that is offset from the first interface along a direction of travel of the automated fiber placement head.

In some aspects, the techniques described herein relate to a method, further including cutting a third tow of the plurality of tows within the tow deposition assembly into a third upstream tow portion and a third downstream tow portion simultaneously with the cutting of the first tow; and continuing to supply the third tow through the compaction roller to apply the third tow to the substrate such that a trailing edge of the third upstream tow portion substantially aligns with a leading edge of the third downstream tow portion at a third interface that is not offset from the first interface along a direction of travel of the automated fiber placement head.

In some aspects, the techniques described herein relate to a method, further including: cutting a fourth tow of the plurality of tows within the tow deposition assembly into a fourth upstream tow portion and a fourth downstream tow portion simultaneously with the cutting of the second tow; and continuing to supply the fourth tow through the compaction roller to apply the fourth tow to the substrate such that a trailing edge of the fourth upstream tow portion substantially aligns with a leading edge of the fourth downstream tow portion at a fourth interface that is not offset from the second interface along the direction of travel of the automated fiber placement head.

In some aspects, the techniques described herein relate to a method, wherein at least one of the automated fiber placement head or the substrate continuously moves relative to the other of the automated fiber placement head or the substrate while the trailing edge of the first upstream tow portion and the leading edge of the first downstream tow portion are applied to the substrate.

In some aspects, the techniques described herein relate to a method, wherein the first tow is applied without a gap between the trailing edge of the first upstream tow portion and the leading edge of the first downstream tow portion at the first interface.

In some aspects, the techniques described herein relate to a method, wherein the first tow is applied such that a gap between the trailing edge of the first upstream tow portion and the leading edge of the first downstream tow portion at the first interface is less than a width of the first tow.

In some aspects, the techniques described herein relate to a method, wherein the first interface and the second interface are offset by approximately 180 degrees of rotation about the substrate.

In some aspects, the techniques described herein relate to a method, wherein each of the first upstream tow portion, the first downstream tow portion, the second upstream tow portion, and the second downstream tow portion wrap approximately 360 degrees around the substrate, approximately 540 degrees around the substrate, or approximately 720 degrees around the substrate.

In some aspects, the techniques described herein relate to a method, further including applying the plurality of tows to the substrate to form a tubular structure around the substrate, and curing the tubular structure in a female mold.

In some aspects, the techniques described herein relate to an automated fiber placement system including: an automated fiber placement head including a compaction roller configured to apply a strip including a plurality of tows to a substrate; at least one cutter configured to cut one or more of the tows into an upstream tow portion and a downstream tow portion; and at least one roller configured to advance the upstream tow portion toward the compaction roller; a robotic arm coupled to the automated fiber placement head; and a controller including at least one processor and at least one memory storing instructions that, when executed by the at least one processor, cause the controller to: activate the at least one cutter to cut a first tow of the plurality of tows into a first upstream tow portion and a first downstream tow portion; activate the at least one roller to advance the first upstream tow portion; control the robotic arm to move the compaction roller across the substrate to apply the strip of tows such that a trailing edge of the first upstream tow portion substantially aligns with a leading edge of the first downstream tow portion at a first interface; activate the at least one cutter to cut a second tow of the plurality of tows into a second upstream tow portion and a second downstream tow portion; activate the at least one roller to advance the second upstream tow portion; and continue controlling the robotic arm to move the automated fiber placement head across the substrate to apply the second tow such that a trailing edge of the second upstream tow portion substantially aligns with a leading edge of the second downstream tow portion at a second interface that is offset from the first interface along a direction of travel of the automated fiber placement head.

In some aspects, the techniques described herein relate to a system, wherein the automated fiber placement head includes a separator that separates a first subset of the plurality of tows from a second subset of the plurality of tows upstream of the compaction roller, and the at least one cutter includes a first cutter on a first side of the separator and a second cutter on the second side of the separator.

In some aspects, the techniques described herein relate to a system, wherein the first cutter is configured to cut all of the tows in the first subset simultaneously, and the second cutter is configured to cut all of the tows in the second subset simultaneously.

In some aspects, the techniques described herein relate to a system, wherein the first cutter is configured to cut only one of the tows in the first subset at a time, and the second cutter is configured to cut only one of the tows in the second subset at a time.

In some aspects, the techniques described herein relate to a system, further including a motor configured to rotate the substrate, wherein the instructions further cause the controller to control the motor and the robotic arm such that the strip of tows is repeatedly wrapped around the substrate.

In some aspects, the techniques described herein relate to a system, wherein the first interface and the second interface are offset by 180 degrees of rotation about the substrate.

In some aspects, the techniques described herein relate to a system, wherein the at least one cutter is activated such that each of the first upstream tow portion, the first downstream tow portion, the second upstream tow portion, and the second downstream tow portion wrap approximately 360 degrees around the substrate, approximately 540 degrees around the substrate, or approximately 720 degrees around the substrate.

In some aspects, the techniques described herein relate to a system, wherein the at least one roller is activated concurrently with or immediately after the activating the at least one cutter, such that there is no gap between the trailing edge of the first upstream tow portion and the leading edge of the first downstream tow portion or such that a gap between the trailing edge of the first upstream tow portion and the leading edge of the first downstream tow portion is less than a width of the first tow.

In some aspects, the techniques described herein relate to a spar of a rotor blade, the spar including a tubular structure formed of a plurality of carbon fiber tows, the plurality of carbon fiber tows including a strip of adjacent parallel tows deposited in a single pass from an automated fiber placement machine, wherein an end of a first tow in the strip and an end of a second tow in the strip are offset by at least 10 degrees of rotation about a longitudinal axis of the spar.

In some aspects, the techniques described herein relate to a spar, wherein the strip of adjacent parallel tows includes at least four tows, wherein the first tow is one of a first set of at least two tows, and the second tow is one of a second set of at least two tows, wherein ends of the first set of tows are aligned, and ends of the second set of tows are aligned.

In some aspects, the techniques described herein relate to a spar, wherein the first set of tows and the second set of tows alternate along the width of the strip.

### BRIEF DESCRIPTION OF THE DRAWINGS

FIG. 1 is a schematic front view of an automated fiber placement head, according to some embodiments.

FIG. 2 is a schematic view of an automated fiber placement head applying strips of tows onto a substrate.

FIG. 3 is a schematic view of an automated fiber placement head applying a strip of tows onto a substrate.

FIGS. 4, 5 and 6 are top views of strips of carbon fiber tows, according to some embodiments.

FIG. 7 is a side view of the automated fiber placement head of FIG. 1 applying a strip of carbon fiber tows to a substrate, according to some embodiments.

FIG. 8 is a method of operating an automated fiber placement head, according to some embodiments.

FIGS. 9, 10, 11, 12, 13 and 14 are side views of the automated fiber placement head of FIG. 1 executing the operations of the method of FIG. 8.

FIG. 15 is a method of operating an automated fiber placement head, according to some embodiments.

FIG. 16 is a schematic view of an automated fiber placement system, according to some embodiments.

FIG. 17 is a cross-sectional view of a rotor blade of a rotary wing aircraft, according to an exemplary embodiment.

FIG. 18 is partial section top view of the rotor blade of FIG. 17.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

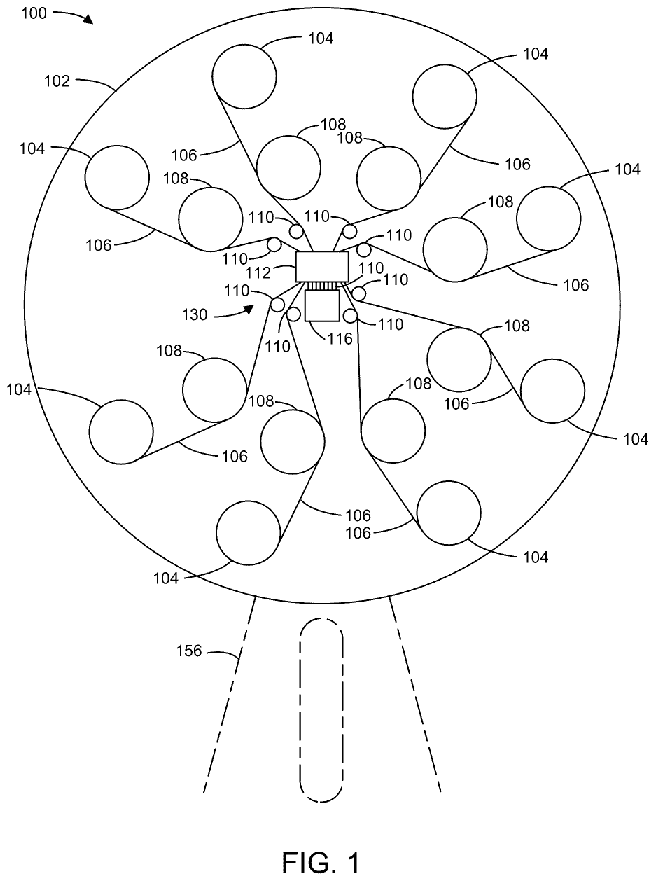

FIG. 1 is a schematic front view of an AFP head 100, according to some embodiments. In the embodiment shown, the AFP head 100 includes eight spool assemblies 104 coupled to a frame 102. In some embodiments, the AFP head 100 may have more (e.g., 16) or fewer (e.g., 4) spool assemblies 104. The spool assemblies 104 include a tow spool of carbon fiber material with backing film to prevent sticking. Each tow 106 is fed through a backing removal spool 108, which removes the backing film. Each tow 106 may then travel around one or more additional rollers 110 to, e.g., adjust tension in the tow 106 and/or redirect the tow 106. The tows 106 then travel to a collimator 112 that arranges the tows 106 into a strip 114 of parallel tows 106. The strip 114 is then fed through a tow deposition assembly 130 to a compaction roller 116 configured to roll the strip 114 onto a surface of a substrate, such as a mandrel. The AFP head 100 may include additional rollers, sensors, and other features not shown. The AFP head 100 may include, for example, a heat source (e.g., a heat lamp) for heating the substrate before laying the tows 106 to increase the tackiness of the substrate such that the tows 106 properly adhere to the substrate. The AFP head 100 may be attached to a multi-axis machine (e.g., a robotic arm 156) configured to control the position of the AFP head 100, allowing for precise control of the location where the tows are deposited over a contoured surface.

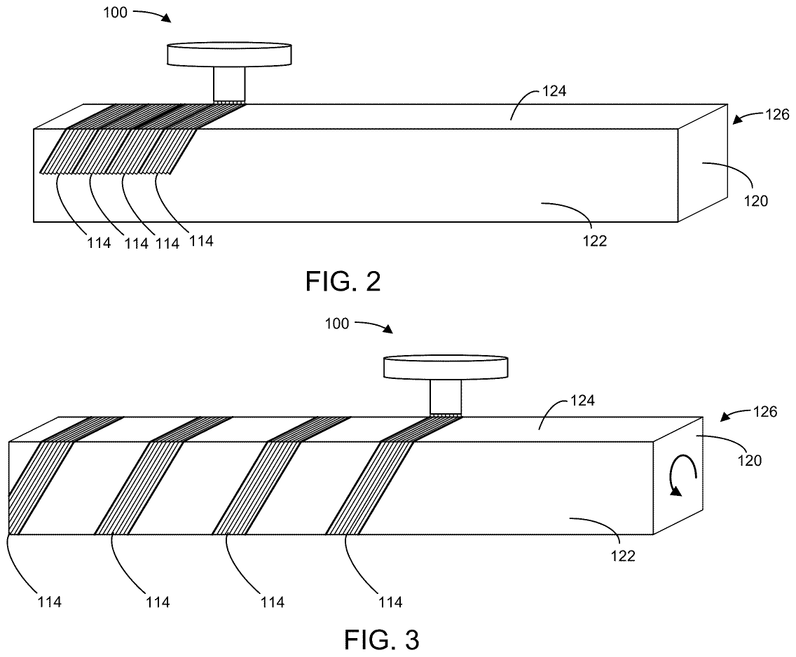

Referring now to FIGS. 2 and 3, two methods of applying carbon fiber tows 106 to an elongated substrate 120 are shown. In FIG. 2, the AFP head 100 applies a first strip 114 of tows 106 around half of the substrate 120 to form a “clamshell” layer, as discussed above, by applying the strip 114 across the upper half of the front side 122, the top 124, and the upper half of the rear side 126 of the substrate 120. Because the compaction roller 116 may be arranged unidirectionally, to lay the next strip 114, the AFP head 100 may be lifted off of the surface of the substrate 120, rotated 180 degrees to reorient the compaction roller 116, and translated such that the compaction roller 116 is positioned above the substrate 120 offset from the first strip 114. The AFP head 100 may then be lowered to lay the second strip in the opposite direction as the first strip. Alternatively, the AFP head 100 may not be rotated and may instead be lifted off of the substrate 120, translated back to the opposite side of the substrate 120 (e.g., offset from the beginning of the first strip 114), and lowered to lay the second strip 114 in the same direction as the first strip 114. In either case, the amount of off-part time when using the clamshell method with AFP may be excessive. Experimental data has shown that the off-part machine motion using the clamshell method with AFP accounts for a majority of the machine motion required to apply all of the tows 106 to the substrate 120.

In FIG. 3, rather than using the clamshell method, a single strip 114 is repeatedly and continuously wrapped around the substrate 120 without cutting or breaking the tows 106. This may be accomplished, for example, by rotating the substrate 120 about its longitudinal axis. In some embodiments, the substrate 120 may be cantilevered, and the AFP head 100 may be moved (e.g., by a robotic arm) around the substrate 120 while the substrate 120 is held stationary. In either case, the AFP head 100 may not need to stop applying the strip 114 to break the tows 106 except, for example, to replace tow spools or to change direction for a subsequent layer of tows 106. For example, after wrapping a first layer of tows 106 at approximately 45 degrees around the substrate 120, a second layer of tows 106 may be wrapped on top of the first layer at approximately 135 degrees (or approximately −45 degrees). It should be understood that the angles described herein are to the longitudinal axis of the substrate 120, such the end of a strip 114 laid at approximately 90 degrees would meet the beginning of the strip 114 after wrapping once around the substrate 120.

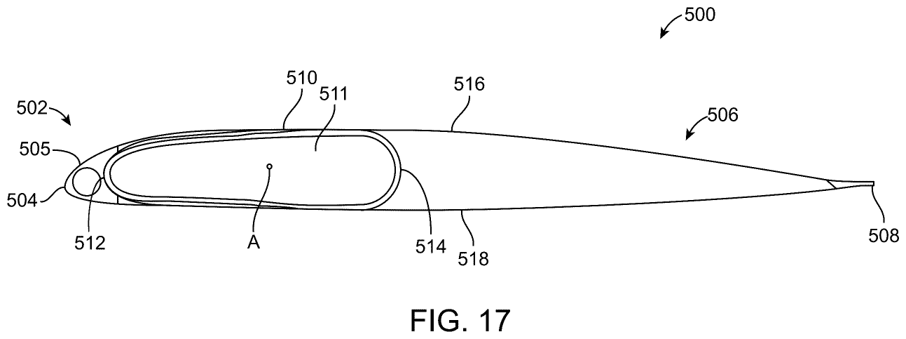

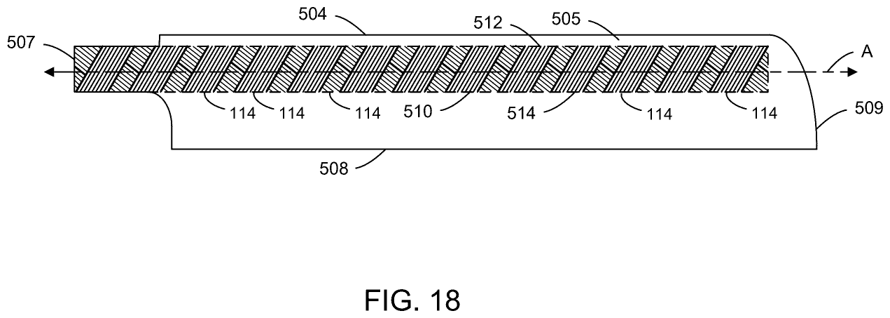

As discussed above, continuously wrapping the strip 114 around the substrate 120 may result in a pre-cured part (e.g., a rotor blade spar as shown in FIGS. 17 and 18) that is not able to expand into a female mold when cured. For example, the spar may be a spar as disclosed in U.S. Patent Application Publication No. 2023/0067333, the entire contents of which are incorporated herein by reference, including for the spar and blade geometries, construction, and details shown therein. The lack of cuts in the strip 114 may restrict the growth of the part. Accordingly, it may be useful to use the wrapping method (e.g., as opposed to the clamshell method) to reduce the amount of off-part time, while also adding cuts to the tows 106 to allow for expansion during curing.

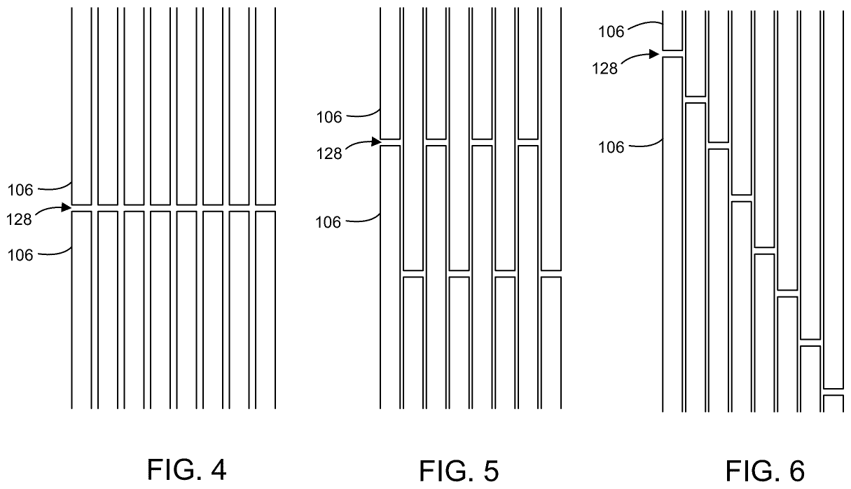

FIGS. 4-6 each show a strip 114 with cuts 128 in the tows 106, which may act as expansion joints during curing. In FIG. 4, the cuts 128 are aligned for all of the tows 106. This may result in tow wandering, similar to that experienced using the clamshell method, and may create a weak point in the finished part if the gaps formed by the cuts 128 are too large. In FIG. 5, cuts 128 are made in alternating tows 106, such that the cuts in adjacent tows 106 are not aligned. For example, in a strip 114 with eight tows 106, as shown in FIG. 5, the first, third, fifth, and seventh tows 106 in the strip 114 may be cut in the same location. After continuing to lay the strip 114 around the substrate 120, the second, fourth, sixth, and eighth tows 106 may be cut simultaneously. The continuous tows 106 adjacent the cut tows 106 may help guide the cut tows 106 toward the substrate 120, minimizing the likelihood of tow wandering. Further, any weakness caused by the gaps in the tows 106 may be distributed between the two cut 128 locations and compensated for by the adjacent uncut tows 106. Finally, FIG. 6 shows a strip 114 in which each tow 106 is cut in a different location. This may further distribute the weak points at the gaps and minimize tow wandering. In some embodiments, the compaction roller 116 may be configured to apply force differentially to the tows 106. By increasing the contact force on the tows 106 that have been cut, tow wandering can be further reduced.

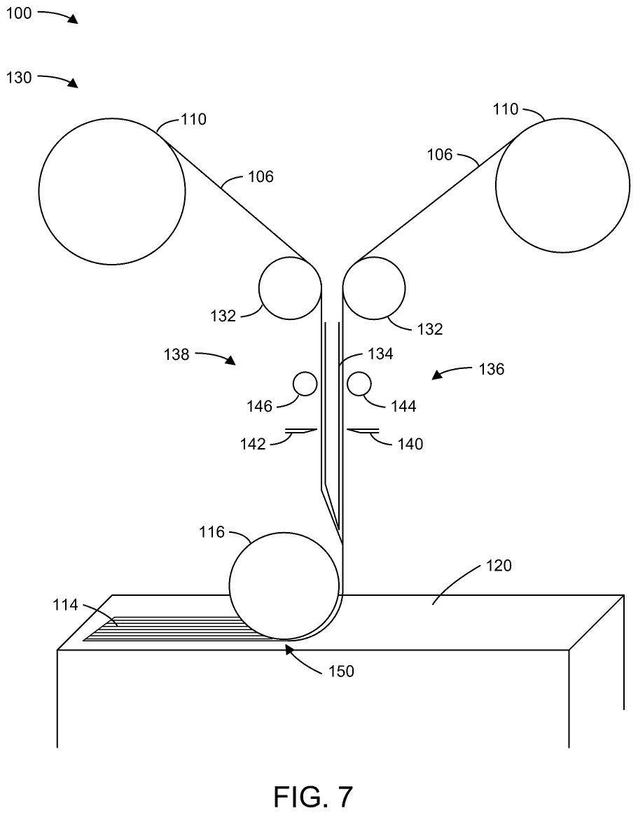

It should be understood that the embodiments shown in FIGS. 5-6 are examples provided by way of illustration and are non-limiting of the present disclosure. Any arrangement or pattern of tow cuts 128 may be used, with any combination of aligned cuts 128 and unaligned cuts 128. Further examples of cut patterns may include aligned cuts 128 in the outermost tows 106 with staggered cuts 128 in the inner tows 106, aligned cuts 128 in every third tow 106 or fourth tow 106 with cuts 128 in adjacent tows 106 being staggered, and aligned cuts 128 between pairs of adjacent tows 106 that are staggered with cuts 128 in adjacent pair or tows 106, to name a few. Further, the distance between cuts 128 in each tow may differ. For example, a first tow 106 may be cut every 360 degrees of wrapping around the substrate while a second tow 106 may be cut every 720 degrees of wrapping around the substrate. The length between cuts in a single tow may also vary. For example, a first tow 106 between first cut 128 and a second cut 128 may wrap 360 degrees around the substrate, and the first tow 106 between the second cut 128 and a third cut 128 may wrap 540 degrees around the substrate. As discussed above, these examples are not meant to be limiting, but illustrate the variety of possible cut patterns that may be achieved using the AFP head 100. Referring now to FIG. 7, a tow deposition assembly 130 of the AFP head 100 is shown, according to some embodiments. The tow deposition assembly 130 includes the components of the AFP head 100 used to align, cut, and place the tows 106 after the backing film has been removed. The tows 106 may travel from the additional rollers 110 (as described with reference to FIG. 1) to the alignment rollers 132, which may be part of the collimator 112. The alignment rollers 132 may align the tows 106 in two subsets on either side 136, 138 of a separator 134. For example, in a strip 114 with eight tows 106, the first, third, fifth, and seventh tows 106 in the strip 114 may be aligned with the first side 136 of the separator 134, and the second, fourth, sixth, and eighth tows 106 may be aligned with the second side 138 of the separator 134. Thus, a tow 106 on the opposite side of the separator 134 may separate each tow 106 on the same side of the separator 134 along the width of the separator (e.g., into the page, as shown in FIG. 7). The tows 106 may be arranged based on the relative locations of the spool assemblies 104, for example, such that tows 106 originating from one side of the frame 102 (e.g., from the four upper spool assemblies 104 in FIG. 1) are aligned with the first side 136 of the separator 134, and tows 106 originating from the other side of the frame 102 (e.g., from the four lower spool assemblies 104 in FIG. 1) are aligned with the second side 138.

The tows 106 travel down the sides 136, 138 to the end of the separator 134 where they are fed to the compaction roller 116, coming into alignment due to the tension from the compaction roller 116. The compaction roller 116 then deposits the tows 106 in a strip 114 on the substrate 120. The tow deposition assembly 130 further includes cutters 140, 142 on each side 136, 138 of the separator 134 for cutting the tows 106. In some embodiments, the cutters 140, 142 may be configured to cut all of the tows 106 on the respective side 136, 138 of the separator 134 (e.g., in the respective subset of tows) simultaneously. In other embodiments, each tow 106 may have a separate cutter 140, 142, such that the tows 106 can be cut individually (such that only one tow 106 is cut at a time). The tow deposition assembly 130 further includes add rollers 144, 146 on each side 136, 138 of the separator 134. The add rollers 144, 146 are configured to advance the upstream portions of the tows 106 after the tows 106 are cut downstream by the cutters 140, 142. In some embodiments, each tow 106 may have a separate add roller 144, 146 (for example, in embodiments in which each tow 106 includes a separate cutter 140, 142). In some embodiments, the add rollers 144, 146 may be configured to advance all of the tows 106 on the respective side 136, 138 of the separator 134 (for example, in embodiments in which the cutters 140, 142 are configured to cut all of the tows 106 on the respective side 136, 138 of the separator 134).

As used herein, “downstream” refers to the direction of travel of the tows 106 from the spool assemblies 104 to the compaction roller 116, while “upstream” refers to the opposite direction. The tows 106 may be referred to as being cut into a “downstream portion” downstream of the cutter 140, 142 and an “upstream portion” upstream of the cutter 140, 142. Before the tows 106 are cut, the compaction roller 116 may pull the tows 106 through the AFP head 100 from the spool assemblies 104 as the tows 106 are laid on the substrate 120. After the tows 106 are cut, however, the portion of the tow 106 upstream of the cut (the upstream portion) can no longer be pulled through by the compaction roller 116. The add rollers 144, 146 may be advanced toward the tow 106 and used to advance the tow 106 until it reaches the compaction roller 116.

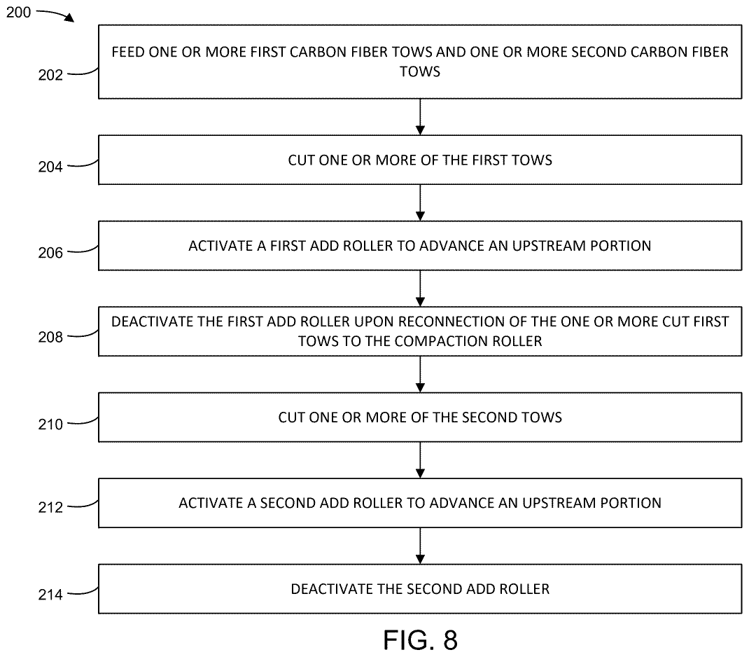

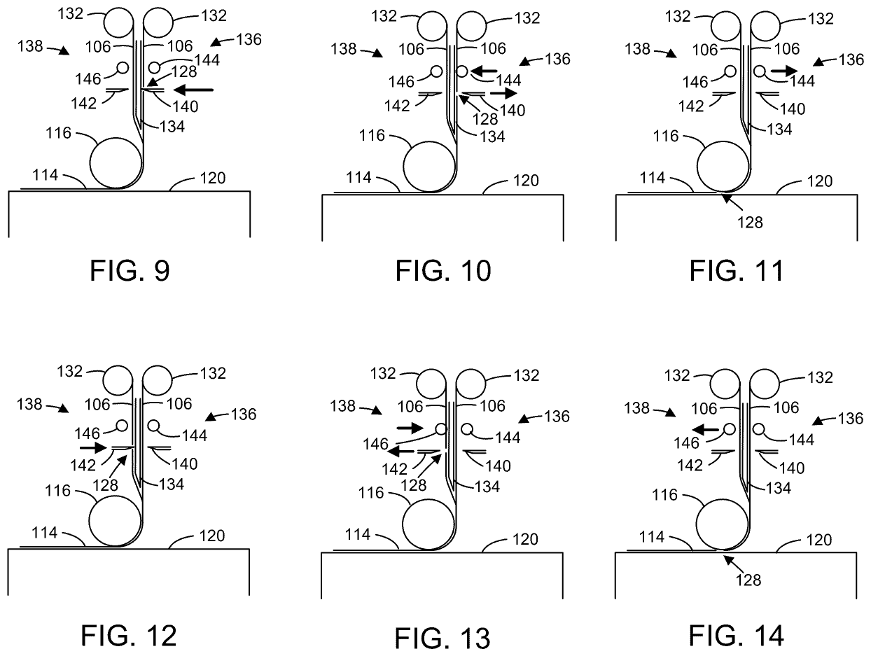

FIG. 8 shows a method of operating an AFP head (e.g., the AFP head 100) according to some embodiments. FIGS. 9-14 show the tow deposition assembly 130 of the AFP head 100 during the various operations of the method 200. At operation 202 of the method 200, one or more first carbon fiber tows are fed along a first side of a separator, and one or more second carbon fiber tows are fed along a second side of the separator to a compaction roller of an AFP head to apply the tows to a substrate. For example, as shown in FIG. 9, first tows 106 are fed along the first side 136 of the separator 134, and second tows 106 are fed along the second side 138 of the separator 134. As discussed above, the tows 106 may be fed to their respective sides 136, 138 based on the location of the spool assemblies 104 on the frame 102, and alternating tows 106 may be fed to opposite sides 136, 138 of the separator 134. The tows 106 travel along the sides 136, 138 of the separator 134 to the compaction roller 116 of the AFP head 100 to apply the tows 106 to the substrate 120.

At operation 204 of the method 200, one or more of the first tows is cut without simultaneously cutting one or more of the second tows. For example, as shown in FIG. 9, all of the first tows 106 are cut by activating the cutter 140. For example, a linear actuator may be actuated causing the cutter 140 to move toward the separator 134, cutting the tows 106 on the first side 136 (e.g., simultaneously or at different times). In some embodiments, each side 136, 138 may have multiple cutters 140, for example, such that each tow 106 can be cut individually rather than cutting all the tows on the side 136, 138. After cutting the first tows 106, the cutter 140 may be immediately retracted, as shown in FIG. 10.

At operation 206 of the method 200, a first add roller is activated to advance an upstream portion of the cut first tow 106 to the compaction roller. For example, as shown in FIG. 10, the first add roller 144 moves toward the separator 134 and rotates to advance the upstream portions of the cut first tows 106 toward the compaction roller 116. The first add roller 144 may be moved towards the separator 134 by, for example, actuating a linear actuator. The first add roller 144 continues to advance the cut tows 106 until they reach the nip line 150, the point at which the tows 106 are pressed between the compaction roller 116 and the substrate 120. Operation 206 may be performed immediately after or at the same time as operation 204, such that the add roller 144 immediately begins advancing the upstream portion of the first tows when the first tows are cut. This may substantially eliminate any gaps between the sections of tows without the need to stop or reset the AFP head. For example, when the cutter 140 is activated, a first tow may be considered to have split into a first tow section downstream of the cutter 140 and a second tow section upstream of the cutter 140. By activating the first add roller 144 immediately after or at the same time as activating the cutter 140, the gap between the leading edge of the second tow section and the trailing edge of the first tow section may be minimized or eliminated, such that the substrate 120 may be continuously or substantially continuously covered by the strip 114 of tows 106. In some embodiments, there may be no gaps between the trailing edge of the upstream portion of a tow and the leading edge of the downstream portion of the tow 106. In some embodiments, a gap between the trailing edge of the upstream portion and the leading edge of the downstream portion is less than a width of the tow 106.

At operation 208, the first add roller is deactivated upon reconnection of the one or more cut first tows to the compaction roller. For example, as shown in FIG. 11, once the cut first tows 106 reach the nip line 150 and the compaction roller 116 resumes pulling the tows through the tow deposition assembly 130 from the spools, the first add roller 144 is retracted (e.g., using the linear actuator).

At operation 210 of the method 100, one or more of the second tows on the other side of the separator are cut without simultaneously cutting one or more of the first tows. Operation 210 may be substantially the same as operation 204, except that tows on the opposite side of the separator 134 are cut. FIG. 12 shows the tow deposition assembly 130 with the second cutter 142 cutting one or more of the second tows 106 (e.g., all of the second tows 106 simultaneously). At operation 212 of the method 100, a second add roller is activated to advance an upstream portion of the cut second tows. Operation 212 may be substantially the same as operation 206, except that an add roller on the opposite side of the separator is activated. FIG. 13 shows the tow deposition assembly 130 with the second add roller 146 activated and advancing the upstream portions of the cut second tows 106. At operation 214 of the method 100, the second add roller is deactivated upon reconnection of the one or more cut second tows to the compaction roller. Operation 214 may be substantially the same as operation 208, except that tows on the opposite side of the separator are cut. FIG. 14 shows the second add roller 146 being deactivated and retracted from the second tows 106 as the second tows 106 reach the nip line 150. While the tows are cut and applied to the substrate, at least one of the substrate or the AFP head may be moving continuously, such that the placement of the tows does not stop due to the cutting of the tows.

In some embodiments, the structure of the AFP head 100 may be different, but the AFP head 100 may still be configured to cut the tows 106, advance the upstream portions of the cut tows 106, and apply the tows 106 to the substrate 120 with no gap or a or small gap between the downstream portions and the upstream portions of the tows 106. For example, in some embodiments, the AFP head 100 may not have a separator, and each of the cutters 140, 142 may be actuated in the same direction, rather than in opposite directions. For example, each tow may have a separate cutter 140, 142, or cutters 140, 142 may include gaps such that the cutter 140, 142 cuts every other tow 106 without cutting the tows 106 therebetween. In some embodiments, one cutter 140, 142 may selectively cut one or more of the tows 106. For example, the cutter 140, 142 may be coupled to a second actuator configured to move the cutter side-to-side to allow the cutter 140, 142 to cut a particular tow 106. After a first tow 106 is cut, the second actuator may reposition the cutter 140, 142 so that a different tow 106 may be cut with the same cutter 140, 142. The add rollers 144, 146 may similarly be actuated to selectively engage different tows 106, for example, based on which tow 106 was most recently cut.

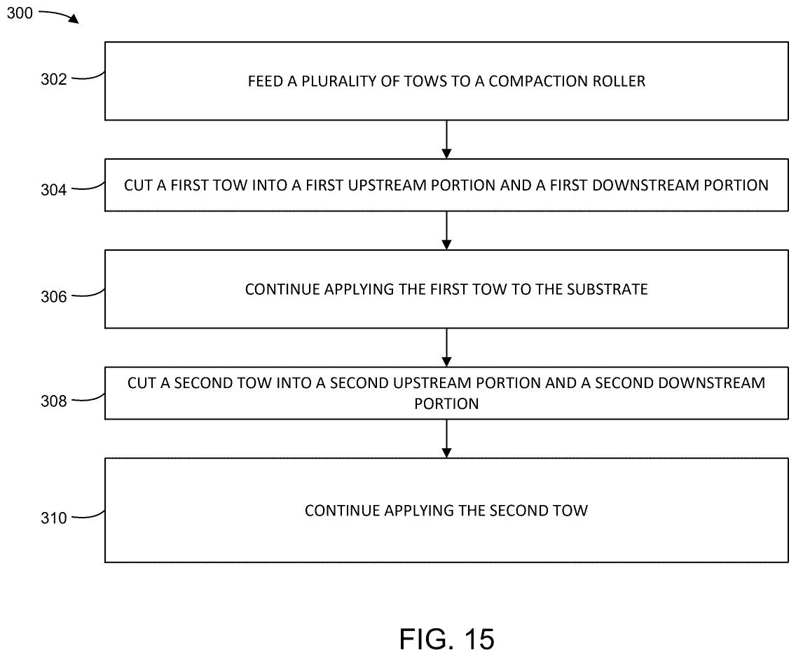

FIG. 15 shows a method 300 of forming a rotor blade spar or other tubular structure, similar to the method 200. At operation 302 of the method 300, a plurality of tows are fed to a compaction roller of an AFP head to apply the tows to a substrate. At operation 304 of the method 300, a first tow of the plurality of tows is cut into a first upstream portion and a first downstream portion. At operation 306 of the method 300, the AFP head continues applying the first tow to the substrate such that a trailing edge of the first upstream tow portion substantially aligns with a leading edge of the first downstream tow portion at a first interface. At operation 308 of the method 300, a second tow of the plurality of tows is cut into a second upstream portion and a second downstream portion. At operation 310 of the method 300, the AFP head continues applying the second tow to the substrate such that a trailing edge of the second upstream tow portion substantially aligns with a leading edge of the second downstream tow portion at a second interface that is significantly offset from the first interface along a direction of travel of the AFP head. As used herein, the term “significantly offset” refers to an offset greater than that which may result from manufacturing imperfections in strips of tows deposited in conventional AFP methods, in which all of the tows are cut simultaneously. In the case of a tubular structure, “significantly offset” may refer to an offset of at least ±1 degree, at least ±5 degrees, or at least −10 degrees of rotation about a longitudinal axis of the tubular structure. The method 300 may further include curing the tubular structure in a female mold.

In some embodiments of the method 300, additional tows (e.g., a third tow) of the plurality of tows may be cut simultaneously with the cutting of the first tow, and other additional tows (e.g., a fourth tow) of the plurality of tows may be cut simultaneously with the cutting of the second tow. Thus, for example, an interface of an upstream portion and a downstream portion of the third tow may substantially align with the first interface along the direction of travel of the AFP head, and an interface of an upstream portion and a downstream portion of the fourth tow may substantially align with the second interface along the direction of travel of the automated fiber placement head. At least one of the AFP head or the substrate may continuously move relative to the other while the tows are cut and applied to the substrate to form the interfaces. The upstream portions of the tows may be advanced (e.g., using add rollers) such that there is no gap between the trailing edge of the upstream tow portions and the leading edge of the respective downstream tow portions, or such that a gap therebetween is less than the width of the tow. The first and second interfaces may be offset from each other by 180 degrees of rotation about the substrate (e.g., about the longitudinal axis of the substrate). In some embodiments, the first and second interfaces may be offset from each other by a different amount (e.g., approximately ±90 degrees, approximately ±60 degrees, approximately ±120 degrees, approximately ±45 degrees, etc.).

In some embodiments, each of the first upstream tow portion, the first downstream tow portion, the second upstream tow portion, and the second downstream tow portion wrap approximately 360 degrees around the substrate, approximately 540 degrees around the substrate, or approximately 720 degrees around the substrate. In some embodiments, the tow portions may wrap around the substrate by a different amount. It should be understood that the degrees of rotation mentioned above refer to the rotational distance around the longitudinal axis of the substrate 120. For example, interfaces being offset by approximately ±180 degrees may mean that one interface is at the center of the top surface of the substrate 120 and the other interface is at the center of the bottom surface of the substrate 120. A tow 106 that is wrapped approximately ±720 degrees around the substrate 120 is wrapped twice around the entire substrate 120, for example, at an angle of approximately ±45 degrees to the longitudinal axis of the substrate such that the tow does not overlap itself.

The method 300 may be repeated such that each of the first tow and the second tow are cut several times to form multiple interfaces. It should be understood that the second interface being “offset” from the first interface refers to a second interface that is offset from the closest first interface formed by cutting the first tow. Thus, for example, if each tow portion wraps approximately ±360 degrees around the substrate, an interface in the second substrate would not be considered “offset” from an interface in the first substrate approximately ±360 degrees away from the interface in the second substrate if there is another interface in the first substrate that is not offset from the interface in the second substrate.

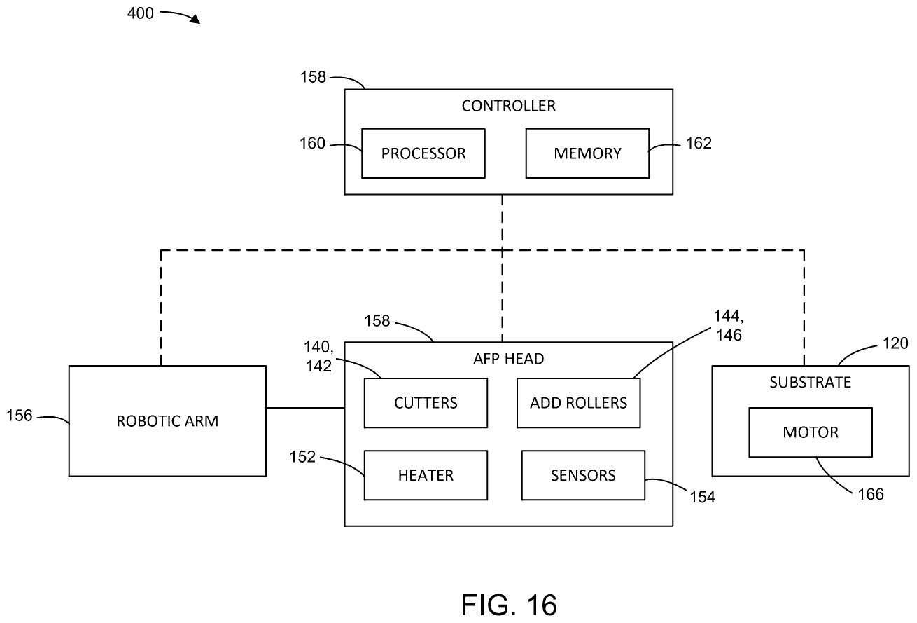

Referring now to FIG. 16, an AFP system 400 is shown, according to some embodiments. The AFP system 400 includes the AFP head 100, including cutters 140, 142, add rollers 144, 146, and the automation equipment (e.g., motors, actuators, etc.) used to activate or operate the cutters 140, 142 and add rollers 144, 146. The AFP head 100 may further include additional components, such as a heater 152 and sensors 154. The AFP system 400 further includes a robotic arm 156 to which the AFP head 100 is coupled and a substrate 120 on which the tows are deposited to form a structure (e.g., a tubular structure, a rotor blade spar, etc.). The robotic arm 156 may include automation equipment, such as motors and actuators, for positioning the AFP head 100 so that tows 106 can be applied to the substrate 120. The substrate 120 may also include or be coupled to automation equipment (e.g., motors, actuators, etc.) configured to move or rotate the substrate 120. For example, the substrate 120 may be coupled to a motor 166 (e.g., via a gearbox) configured to rotate the substrate 120 about its linear axis so that all sides of the substrate 120 can be accessed by the AFP head 100.

The AFP system 400 further includes a controller 158 comprising at least one processor 160 and at least one memory 162 that is communicably coupled to the other components of the AFP system 400. The at least one memory 162 may store instructions that, when executed by the processor, cause the controller 158 to operate the other components of the AFP system 400, for example, to perform the functions and methods described herein (e.g., the operations of the methods 200, 300). For example, the controller 158 may operate the actuators of the robotic arm 156 and the motor of the substrate to position the AFP head 100 on the substrate 120 and apply tows from the AFP head 100 to the substrate 120. The controller 158 may operate the cutters 140, 142 and add rollers 144, 146 to cut the tows 106 and advance the upstream portions of the cut tows.

Referring to FIGS. 17 and 18, a cross section and a partial-section top view of a rotor blade 500 are respectively shown, in accordance with an exemplary embodiment. The rotor blade 500 includes a leading edge portion 502 including a leading edge 504 (e.g., a forward edge) that defines a forward end of the rotor blade, and a trailing edge portion 506 including a trailing edge 508 (e.g., an aft edge) that defines an aft edge of the rotor blade. The rotor blade 500 includes a spar 510. The spar 510 is a tubular structure, the cross section of which is roughly oval in shape and provides structural support to the rotor blade 500. The spar 510 also includes a leading edge 512 (e.g., a forward edge) defining a forward end of the spar 510, and a trailing edge 514 (e.g., an aft edge) defining an aft end of the spar. The spar 510 begins at the inboard root 507 of the rotor blade 500 and extends most of the way to the outboard tip 509 of the rotor blade 500. The spar 510 defines an internal cavity 511 that may be filled with a lightweight material such as foam, or may remain an empty space. The outer surface of the rotor blade 500 includes an upper skin 516 and a lower skin 518 that are bonded to the spar 510 and extend to the trailing edge portion 506 to form the trailing edge 508, as well as a leading edge sheath 505 at the leading edge portion 502 that forms the leading edge 504. The upper and lower skins 516, 518 may be made from titanium, aluminum, stainless, steel, carbon fiber, fiberglass, or any other appropriate material.

As shown in FIGS. 17 and 18, the spar 510 is manufactured using AFP according to the methods discussed above. FIG. 18 shows the strips 114 of parallel carbon fiber tows 106 that form the tubular structure of the spar 510. As discussed above, the strips 114 of adjacent parallel tows 106 may be deposited in a single pass from an AFP machine onto a mandrel. The strips 114 of tows 106 may be cured and the mandrel may be removed, leaving a tubular spar 510 formed of the strips 114 of tows 106. The ends of a first tow 106 in the strip 114 may be significantly offset from the ends of a second tow 106 in the strip 114 about a longitudinal axis A of the spar 510. The ends of the tows 106 may be arranged in any of the patterns discussed above, including those illustrated in FIGS. 4-6. For example, each strip 114 of adjacent parallel tows 106 in the spar 510 may include at least four tows 106, with the first tow being one of a first set of at least two tows, the second tow 106 being one of a second set of at least two tows 106, the ends of the first set of tows 106 being aligned, and the ends of the second set of tows 106 being aligned. The first set of tows 106 and the second set of tows 106 may alternate along the width of the strip 114, as shown in FIG. 5. While this specification contains specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims. More particularly, various numerical values herein are provided for reference purposes only. Unless otherwise indicated, all numbers expressing quantities of properties, parameters, conditions, and so forth, used in the specification and claims are to be understood as being modified in all instances by the term “approximately” or “about.” Accordingly, unless indicated to the contrary, the numerical parameters set forth in the following specification and attached claims are approximations. Any numerical parameter should at least be construed in light of the number reported significant digits and by applying ordinary rounding techniques. The term “approximately” or “about” when used before a numerical designation, e.g., a quantity and/or an amount including range, indicates approximations which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

What is claimed is:

1. A method of operating an automated fiber placement system, the method comprising:
supplying a plurality of tows to a tow deposition assembly of an automated fiber placement head of the automated fiber placement system, the plurality of tows including a first tow and a second tow;
cutting the first tow of the plurality of tows within the tow deposition assembly into a first upstream tow portion and a first downstream tow portion;
continuing to supply the first tow through a compaction roller of the automated fiber placement head to apply the first tow to a substrate such that a trailing edge of the first upstream tow portion substantially aligns with a leading edge of the first downstream tow portion at a first interface;
cutting the second tow of the plurality of tows within the tow deposition assembly into a second upstream tow portion and a second downstream tow portion; and
continuing to supply the second tow through the compaction roller to apply the second tow to the substrate such that a trailing edge of the second upstream tow portion substantially aligns with a leading edge of the second downstream tow portion at a second interface that is offset from the first interface along a direction of travel of the automated fiber placement head.

2. The method of claim 1, further comprising:
cutting a third tow of the plurality of tows within the tow deposition assembly into a third upstream tow portion and a third downstream tow portion simultaneously with the cutting of the first tow; and
continuing to supply the third tow through the compaction roller to apply the third tow to the substrate such that a trailing edge of the third upstream tow portion substantially aligns with a leading edge of the third downstream tow portion at a third interface that is not offset from the first interface along a direction of travel of the automated fiber placement head.

3. The method of claim 2, further comprising:
cutting a fourth tow of the plurality of tows within the tow deposition assembly into a fourth upstream tow portion and a fourth downstream tow portion simultaneously with the cutting of the second tow; and
continuing to supply the fourth tow through the compaction roller to apply the fourth tow to the substrate such that a trailing edge of the fourth upstream tow portion substantially aligns with a leading edge of the fourth downstream tow portion at a fourth interface that is not offset from the second interface along the direction of travel of the automated fiber placement head.

4. The method of claim 1, wherein at least one of the automated fiber placement head or the substrate continuously moves relative to the other of the automated fiber placement head or the substrate while the trailing edge of the first upstream tow portion and the leading edge of the first downstream tow portion are applied to the substrate.

5. The method of claim 1, wherein the first tow is applied without a gap between the trailing edge of the first upstream tow portion and the leading edge of the first downstream tow portion at the first interface.

6. The method of claim 1, wherein the first tow is applied such that a gap between the trailing edge of the first upstream tow portion and the leading edge of the first downstream tow portion at the first interface is less than a width of the first tow.

7. The method of claim 1, wherein the first interface and the second interface are offset by approximately 180 degrees of rotation about the substrate.

8. The method of claim 7, wherein each of the first upstream tow portion, the first downstream tow portion, the second upstream tow portion, and the second downstream tow portion wrap approximately 360 degrees around the substrate, approximately 540 degrees around the substrate, or approximately 720 degrees around the substrate.

9. The method of claim 1, further comprising applying the plurality of tows to the substrate to form a tubular structure around the substrate, and curing the tubular structure in a female mold.

10. An automated fiber placement system comprising:
an automated fiber placement head comprising:
a compaction roller configured to apply a strip comprising a plurality of tows to a substrate;
at least one cutter configured to cut one or more of the tows into an upstream tow portion and a downstream tow portion; and
at least one roller configured to advance the upstream tow portion toward the compaction roller;
a robotic arm coupled to the automated fiber placement head; and
a controller comprising at least one processor and at least one memory storing instructions that, when executed by the at least one processor, cause the controller to:
activate the at least one cutter to cut a first tow of the plurality of tows into a first upstream tow portion and a first downstream tow portion;
activate the at least one roller to advance the first upstream tow portion;
control the robotic arm to move the compaction roller across the substrate to apply the strip of tows such that a trailing edge of the first upstream tow portion substantially aligns with a leading edge of the first downstream tow portion at a first interface;
activate the at least one cutter to cut a second tow of the plurality of tows into a second upstream tow portion and a second downstream tow portion;
activate the at least one roller to advance the second upstream tow portion; and
continue controlling the robotic arm to move the automated fiber placement head across the substrate to apply the second tow such that a trailing edge of the second upstream tow portion substantially aligns with a leading edge of the second downstream tow portion at a second interface that is offset from the first interface along a direction of travel of the automated fiber placement head.

11. The system of claim 10, wherein the automated fiber placement head comprises a separator that separates a first subset of the plurality of tows from a second subset of the plurality of tows upstream of the compaction roller, and the at least one cutter comprises a first cutter on a first side of the separator and a second cutter on the second side of the separator.

12. The system of claim 11, wherein the first cutter is configured to cut all of the tows in the first subset simultaneously, and the second cutter is configured to cut all of the tows in the second subset simultaneously.

13. The system of claim 11, wherein the first cutter is configured to cut only one of the tows in the first subset at a time, and the second cutter is configured to cut only one of the tows in the second subset at a time.

14. The system of claim 10, further comprising a motor configured to rotate the substrate, wherein the instructions further cause the controller to control the motor and the robotic arm such that the strip of tows is repeatedly wrapped around the substrate.

15. The system of claim 14, wherein the first interface and the second interface are offset by 180 degrees of rotation about the substrate.

16. The system of claim 15, wherein the at least one cutter is activated such that each of the first upstream tow portion, the first downstream tow portion, the second upstream tow portion, and the second downstream tow portion wrap approximately 360 degrees around the substrate, approximately 540 degrees around the substrate, or approximately 720 degrees around the substrate.

17. The system of claim 10, wherein the at least one roller is activated concurrently with or immediately after the activating the at least one cutter, such that there is no gap between the trailing edge of the first upstream tow portion and the leading edge of the first downstream tow portion or such that a gap between the trailing edge of the first upstream tow portion and the leading edge of the first downstream tow portion is less than a width of the first tow.

18. A spar of a rotor blade, the spar comprising a tubular structure formed of a plurality of carbon fiber tows, the plurality of carbon fiber tows comprising a strip of adjacent parallel tows deposited in a single pass from an automated fiber placement machine, wherein an end of a first tow in the strip and an end of a second tow in the strip are offset by at least 10 degrees of rotation about a longitudinal axis of the spar.

19. The spar of claim 18, wherein the strip of adjacent parallel tows comprises at least four tows, wherein the first tow is one of a first set of at least two tows, and the second tow is one of a second set of at least two tows, wherein ends of the first set of tows are aligned, and ends of the second set of tows are aligned.

20. The spar of claim 19, wherein the first set of tows and the second set of tows alternate along the width of the strip.
